(19) United States
(12) Patent Application Publication
(10) Pub. No.: US 2026/0179354 A1
(43) Pub. Date: Jun. 25, 2026

(54) IDENTITY RECOGNITION METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Shaoming WANG, Shenzhen (CN); Runzeng GUO, Shenzhen (CN); Jinkun HOU, Shenzhen (CN)

(21) Appl. No.: 19/354,799

(22) Filed: Oct. 9, 2025

Related U.S. Application Data
(63) Continuation of application No. PCT/CN2024/108347, filed on Jul. 30, 2024.

(30) Foreign Application Priority Data
Sep. 28, 2023 (CN) 202311279949.5

(51) Int. Cl. G06V 10/60; G06V 10/56; G06V 10/764; G06V 10/776; G06V 40/12

(52) U.S. Cl. CPC G06V 10/60; G06V 10/56; G06V 10/764; G06V 40/1347; G06V 10/776

(57) ABSTRACT

An identity recognition method performed by a computer device includes obtaining a target image, the target image comprising an image formed from at least a part of a target object; extracting a color feature of the target image; recognizing, based on the color feature of the target image, a target environmental category corresponding to the target image, different environmental categories being configured for characterizing different ambient light scenarios; and obtaining, based on the target environmental category, a target identity recognition algorithm matching the target image, and performing identity recognition on the target image based on the target identity recognition algorithm, to obtain an identity recognition result of the target object, different environmental categories corresponding to different identity recognition algorithms.

### CROSS-REFERENCES TO RELATED APPLICATIONS

This application is a continuation application of PCT Patent Application No. PCT/CN2024/108347, filed on Jul. 30, 2024, which claims priority to Chinese Patent Application No. 2023112799495, filed on Sep. 28, 2023, all of which is incorporated herein by reference in their entirety.

### FIELD OF THE TECHNOLOGY

The present disclosure relates to the field of computer technologies, and in particular, to an identity recognition method and apparatus, a computer device, a storage medium, and a computer program product.

### BACKGROUND OF THE DISCLOSURE

With development of computer technologies, identity recognition technologies have been widely applied. Identity recognition is primarily performed to recognize an image (for example, a facial image, an iris image, or a palm image) by using complex algorithms and models, to determine a biological object corresponding to the image.

In the related art, accuracy of identity recognition depends on quality of an image acquired by an image acquisition device. However, imaging (or image formation) may depend on lamp light in an environment in which the image acquisition device is located. Backlighting or light interference may cause the image to be too dark or too bright. This makes the acquired image prone to loss of details in bright or dark regions, affecting quality of the image, and further affecting accuracy of identity recognition.

### SUMMARY

One embodiment of the present disclosure provides an identity recognition method, performed by a computer device. The method includes obtaining a target image, the target image including an image formed from at least a part of a target object; extracting a color feature of the target image; recognizing, based on the color feature of the target image, a target environmental category corresponding to the target image, different environmental categories being configured for characterizing different ambient light scenarios; and obtaining, based on the target environmental category, a target identity recognition algorithm matching the target image, and performing identity recognition on the target image based on the target identity recognition algorithm, to obtain an identity recognition result of the target object, different environmental categories corresponding to different identity recognition algorithms.

Another embodiment of the present disclosure provides a computer device. The computer device includes one or more processors and a memory containing a computer program that, when being executed, causes the one or more processors to perform: obtaining a target image, the target image including an image formed from at least a part of a target object; extracting a color feature of the target image; recognizing, based on the color feature of the target image, a target environmental category corresponding to the target image, different environmental categories being configured for characterizing different ambient light scenarios; and obtaining, based on the target environmental category, a target identity recognition algorithm matching the target image, and performing identity recognition on the target image based on the target identity recognition algorithm, to obtain an identity recognition result of the target object, different environmental categories corresponding to different identity recognition algorithms.

Another embodiment of the present disclosure provides a non-transitory computer-readable storage medium containing a computer program that, when being executed, causes at least one processor to perform: obtaining a target image, the target image including an image formed from at least a part of a target object; extracting a color feature of the target image; recognizing, based on the color feature of the target image, a target environmental category corresponding to the target image, different environmental categories being configured for characterizing different ambient light scenarios; and obtaining, based on the target environmental category, a target identity recognition algorithm matching the target image, and performing identity recognition on the target image based on the target identity recognition algorithm, to obtain an identity recognition result of the target object, different environmental categories corresponding to different identity recognition algorithms.

Details of one or more embodiments of the present disclosure will be proposed in the following drawings and descriptions. Other features, objectives, and advantages of the present disclosure will become apparent in the specification, the drawings, and the claims.

### BRIEF DESCRIPTION OF THE DRAWINGS

To describe the technical solutions in embodiments of the present disclosure more clearly, the following briefly describes the accompanying drawings required for describing the embodiments. Apparently, the accompanying drawings in the following descriptions show merely the embodiments of the present disclosure, and a person of ordinary skill in the art may still derive other accompanying drawings from the disclosed accompanying drawings without creative efforts.

FIG. 1 is a diagram of an application environment of an identity recognition method according to an embodiment of the present disclosure.

FIG. 2 is a schematic diagram of application of an identity recognition method according to an embodiment of the present disclosure.

FIG. 3 is a schematic flowchart of an identity recognition method according to an embodiment of the present disclosure.

FIG. 4 is a schematic diagram of RGB channel-combined colors according to an embodiment of the present disclosure.

FIG. 5 is a schematic diagram of an RGB coordinate system according to an embodiment of the present disclosure.

FIG. 6 is a schematic diagram of obtaining an image classification model according to an embodiment of the present disclosure.

FIG. 7 is a schematic diagram of a brightness distribution of an image according to an embodiment of the present disclosure.

FIG. 8 is a schematic diagram of a brightness distribution of an image according to another embodiment of the present disclosure.

FIG. 9 is a schematic diagram of a brightness distribution of an image according to still another embodiment of the present disclosure.

FIG. 10 is a schematic diagram of establishing a correspondence between an image acquisition device and an environmental category according to an embodiment of the present disclosure.

FIG. 11 is a schematic diagram of an identity recognition system according to an embodiment of the present disclosure.

FIG. 12 is a schematic diagram of an image acquisition scenario according to an embodiment of the present disclosure.

FIG. 13 is a block diagram of a structure of an identity recognition apparatus according to an embodiment of the present disclosure.

FIG. 14 is a diagram of an internal structure of a computer device according to an embodiment of the present disclosure.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

The embodiments of the present disclosure may be applied to various scenarios, including but not limited to a cloud technology, artificial intelligence, smart transportation, assisted driving, and the like.

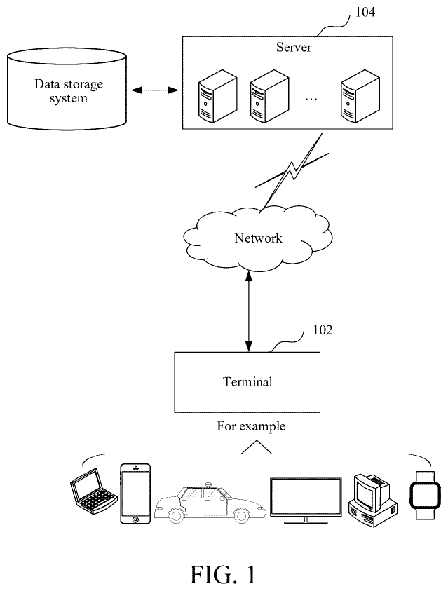

An identity recognition method provided in an embodiment of the present disclosure may be applied to an application environment shown in FIG. 1. A terminal 102 (or a terminal device) communicates with a server 104 through a network. A data storage system may store data to be processed by the server 104. The data storage system may be integrated on the server 104, or may be placed on a cloud or another server. The terminal 102 may be but is not limited to various desktop computers, notebook computers, smartphones, tablet computers, Internet of things devices, and portable wearable devices. The Internet of things device may be a smart speaker, a smart television, a smart air conditioner, a smart in-vehicle device, or the like. The portable wearable device may be a smartwatch, a smart band, a head-mounted device, or the like. The server 104 may be implemented by using an independent server or a server cluster including a plurality of servers.

Specifically, the terminal 102 and the server 104 may be configured to perform the identity recognition method alone, or the terminal 102 and the server 104 may jointly perform the identity recognition method. For example, the terminal 102 may be provided with a built-in image acquisition device. When identity recognition needs to be performed on a to-be-recognized object, the terminal 102 may invoke the image acquisition device to acquire a target image. The terminal 102 may locally perform the identity recognition method. To be specific, the terminal 102 locally recognizes a target environmental category corresponding to the target image, obtains, based on the target environmental category, a target identity recognition algorithm matching the target image, and performs identity recognition on the target image based on the target identity recognition algorithm, to obtain an identity recognition result of the to-be-recognized object.

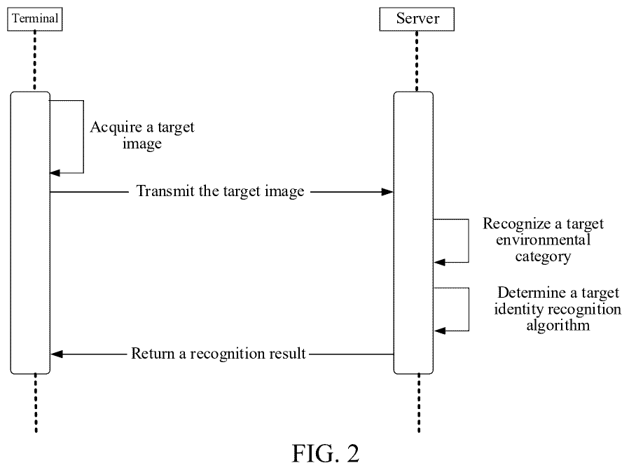

In an embodiment, as shown in FIG. 2, the terminal 102 may alternatively transmit the acquired target image to the server 104. The server 104 recognizes a target environmental category corresponding to the target image, obtains, based on the target environmental category, a target identity recognition algorithm matching the target image, and performs identity recognition on the target image by using the target identity recognition algorithm, to obtain an identity recognition result of the to-be-recognized object. The server 104 may further return the identity recognition result of the to-be-recognized object to the terminal 102.

The terminal 102 may be specifically a service processing device. When the identity recognition method is applied to an access control system, the terminal 102 may be specifically an access control device. When the identity recognition method is applied to a payment system, the terminal 102 may be specifically an offline payment device or the like. When the identity recognition method is applied to a different service system requiring identity recognition, the terminal 102 may be specifically a corresponding service processing device.

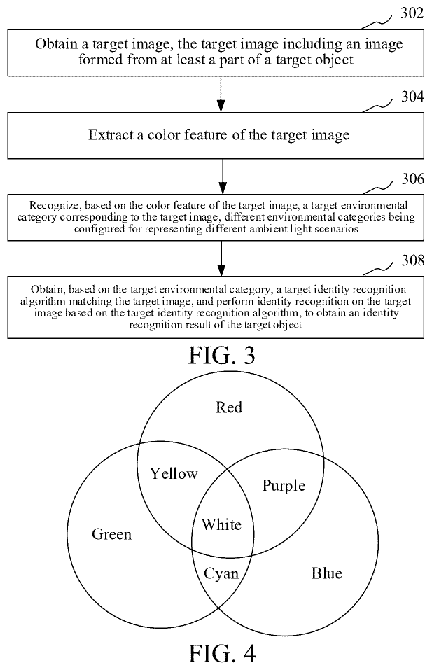

In an embodiment, as shown in FIG. 3, an identity recognition method is provided. An example in which the method is applied to a computer device is used for description. The computer device may be specifically the terminal 102 or the server 104 in FIG. 1. The identity recognition method may include the following operations.

Operation 302: Obtain a target image, the target image including an image formed from at least a part of a to-be-recognized object.

The to-be-recognized object may be a target object on which identity recognition needs to be performed, and may be specifically a target object triggering an identity recognition event. For example, in a payment scenario, the to-be-recognized object or the target object may be a user currently triggering a payment. In an attendance recording scenario, the to-be-recognized object may be a user currently triggering attendance registration.

The target image may be an image of the to-be-recognized object shot based on a need for identity recognition. The target image may include the image formed from at least the part of the to-be-recognized object. Specifically, at least the part of the to-be-recognized object may be the entire to-be-recognized object or a part of the to-be-recognized object. For example, the entire to-be-recognized object may be an entire natural person, and the part of the to-be-recognized object may be a palm, a face, or an eye of the natural person. The image formed from at least the part of the to-be-recognized object may be an image formed by mapping at least the part of the to-be-recognized object to the target image.

Specifically, when the identity recognition method of the present disclosure is locally performed by a terminal, that is, when the computer device is the terminal, the terminal may be provided with a built-in or external image acquisition device. The image acquisition device may be a three-dimensional (3D) camera, for example, a 3D structured light camera, which may include a depth camera, an infrared camera, and the like. When identity recognition needs to be performed on the to-be-recognized object, for example, when the to-be-recognized object triggers the terminal to perform identity recognition, the terminal may invoke the image acquisition device to acquire the target image. The target image includes the image formed from at least the part of the to-be-recognized object. For example, the target image may include a palm image or a facial image corresponding to the to-be-recognized object. When the identity recognition method is specifically performed by a server, that is, when the computer device is the server, the server may obtain the target image that is transmitted by a terminal and that corresponds to the to-be-recognized object.

Operation 304: Extract a color feature of the target image.

Operation 306: Recognize, based on the color feature of the target image, a target environmental category corresponding to the target image, different environmental categories being configured for characterizing different ambient light scenarios.

Different environmental categories are configured for characterizing different ambient light scenarios. The ambient light scenario may be a light intensity related scenario, a light color related scenario, or the like in an environment. The environmental category may be categories preset based on different light intensities and light colors in the environment. Different environmental categories may correspond to different light intensities, different light colors, or different light intensities and different light colors. For example, the environmental category may include a white light category, a dim light category, a stray light category, and the like.

The color feature of the target image is at least configured for characterizing ambient chromaticity information of an ambient light scenario corresponding to the target image. Images acquired in different lamp light environments may present different effects, that is, color features of the images may be different. Different color features may reflect different ambient light scenarios, that is, different color features may represent specific information about light intensities and light colors in different ambient light scenarios.

For example, for an image acquired in a scenario with weak ambient light (that is, when a light intensity is less than a minimum value required for normal image acquisition), the image has poor overall brightness or lightness of the image and presents a dark hue. For an image acquired in a scenario with strong ambient light (that is, when a light intensity is greater than a maximum value required for normal image acquisition), the image has high overall brightness or lightness. For an image acquired in a scenario in which ambient light has a normal intensity (that is, when the light intensity is within a range required for normal image acquisition) and the ambient light is white, the image has high overall brightness or lightness and presents a neutral hue. For images acquired in a lamp light environment with various colors (for example, red, orange, yellow, green, cyan, blue, and purple), the images present different hues and lightness levels.

The target environmental category is determined based on a color feature of the ambient light scenario corresponding to the target image. The color feature is at least configured for characterizing the ambient chromaticity information of the ambient light scenario, and the ambient chromaticity information may be specific information about a light intensity and a light color in an environment. The ambient light scenario corresponding to the target image is an ambient light scenario of an acquisition environment corresponding to the target image. The color feature of the ambient light scenario is configured for reflecting the ambient chromaticity information of the acquisition environment corresponding to the target image. In other words, different color features may reflect different ambient light scenarios and represent different environmental categories.

Images acquired in different lamp light environments may present different effects, that is, color features of the images may be different. Therefore, the corresponding target environmental category may be recognized in real time based on the target image. Specifically, the target environmental category corresponding to the target image may be recognized in real time based on the color feature of the target image. The color feature may be a red-green-blue (RGB) feature, a hue-intensity-saturation (HIS) color feature, a hue-saturation-value (HSV) color feature, or the like of the target image.

In addition, as a service processing device, a terminal (including the image acquisition device) has a fixed deployment scenario, and when the terminal is deployed in a scenario, an environmental category corresponding to the scenario is also fixed, that is, an environmental category of an acquisition environment of the image acquisition device can be determined. Therefore, the target environmental category corresponding to the target image may be further determined based on the environmental category of the environment in which the image acquisition device corresponding to the target image is located. For example, after the image acquisition device is deployed, the corresponding environmental category may be determined by detecting an ambient light scenario of the environment in which the image acquisition device is located, and the environmental category is used as an environmental category corresponding to an image subsequently acquired by the image acquisition device.

The target environmental category corresponding to the target image may be locally recognized by the terminal, or the target environmental category corresponding to the target image transmitted by the terminal may be recognized by the server.

Performing identity recognition on images with different color features by using a same identity recognition algorithm affects recognition accuracy and reduces a recognition success rate. Based on this, in this embodiment, the color feature of the target image is extracted, the target environmental category corresponding to the target image is determined in the subsequent operation, and then identity recognition may be performed on the target image by using a target identity recognition algorithm corresponding to the target environmental category. This improves accuracy of identity recognition.

Specifically, the color feature of the target image may be the RGB feature, the HIS color feature, the HSV color feature, or the like of the target image. Specifically, the color feature may be represented by a vector, a histogram, or the like. For example, an example in which the color feature is the RGB feature is used. The computer device may obtain an RGB value of a pixel of the target image, and obtain a corresponding histogram based on a distribution of the RGB value of the pixel, that is, obtain the color feature of the target image.

Different color features presented by images may reflect different ambient light scenarios and represent different environmental categories. Therefore, the computer device may recognize, based on the color feature of the target image, the target environmental category corresponding to the target image. For example, a correspondence between a color feature and an environmental category may be preset, so that an environmental category corresponding to the color feature of the target image may be obtained based on the color feature, and the environmental category matching the color feature is determined as the target environmental category corresponding to the target image. Alternatively, an environmental category of the target image may be classified based on the color feature of the target image by using a machine learning model, to obtain the target environmental category corresponding to the target image.

In this embodiment, the color feature of the target image is extracted, and the target environmental category corresponding to the target image is recognized based on the color feature of the target image. Specific color features of different ambient light scenarios may be different, leading to different imaging quality and imaging effects in different ambient light scenarios. Therefore, the target environmental category corresponding to the target image may be determined by extracting the color feature of the target image, to implement real-time determining of a category of the acquisition environment of the target image, improving accuracy of determining the category of the acquisition environment of the target image. Further, identity recognition is performed on the target image by using the target identity recognition algorithm corresponding to the target environmental category that is determined in real time, further improving the accuracy of identity recognition.

Operation 308: Obtain, based on the target environmental category, the target identity recognition algorithm matching the target image, and perform identity recognition on the target image based on the target identity recognition algorithm, to obtain an identity recognition result of the to-be-recognized object.

Different environmental categories correspond to different identity recognition algorithms, and differentiated recognition is performed on images in different environmental categories by using different identity recognition algorithms, helping improve the recognition accuracy. The target identity recognition algorithm is an identity recognition algorithm corresponding to the target environmental category. In addition, because the target environmental category is obtained through target identity recognition, and the target image is an acquired image of the to-be-recognized object, the identity recognition result of the to-be-recognized object may be obtained by performing identity recognition on the target image by using the target identity recognition algorithm.

Specifically, identity recognition may be a process of performing identity authentication on the to-be-recognized object, and the identity recognition algorithm is a specific policy used in the process of performing identity authentication on the to-be-recognized object. The identity recognition result is configured for characterizing a result indicating whether identity authentication on the to-be-recognized object succeeds. For example, for the payment scenario, the computer device performs matching between the target image and a user image of a payment-authorized user by using the target identity recognition algorithm. If matching succeeds, the computer device may determine that the to-be-recognized object is the payment-authorized user, so that an identity recognition result indicating that identity authentication on the to-be-recognized object succeeds is obtained. If matching does not succeed, it may be determined that the to-be-recognized object is not the payment-authorized user, so that an identity recognition result indicating that identity authentication on the to-be-recognized object fails is obtained.

A process of performing identity recognition on the target image may be locally performed by the terminal, or may be remotely performed by the server. This is not limited in this embodiment. When the process of performing identity recognition on the target image is remotely performed by the server, the server may further return the identity recognition result of the to-be-recognized object to the terminal, so that the to-be-recognized object may learn the identity recognition result of the to-be-recognized object in real time by using the terminal, improving user experience.

In the foregoing identity recognition method, the target image including the image formed from at least the part of the to-be-recognized object is obtained, the target environmental category corresponding to the target image is recognized, the target identity recognition algorithm matching the target image is obtained based on the target environmental category, and identity recognition is performed on the target image based on the target identity recognition algorithm, to obtain the identity recognition result of the to-be-recognized object. Different environmental categories represent different ambient light scenarios, and different environmental categories correspond to different identity recognition algorithms. Specific color features of different ambient light scenarios may be different, leading to different imaging quality and imaging effects in different ambient light scenarios, and performing recognition processing on images acquired in different ambient light scenarios by using different identity recognition algorithms helps improve image recognition accuracy. Therefore, the target environmental category corresponding to the target image is recognized, and identity recognition is performed on the target image by using the target identity recognition algorithm corresponding to the target environmental category, improving accuracy of recognizing the target image. In addition, the target image includes the image formed from at least the part of the to-be-recognized object, helping improve accuracy of identity recognition on the to-be-recognized object.

In an embodiment, the extracting a color feature of the target image includes: obtaining the RGB value of the pixel of the target image; determining hue information of the target image based on an RGB value distribution of the pixel of the target image; converting the RGB value of the pixel of the target image into a lightness value of the target image; and constructing a color feature vector of the target image based on the lightness value of the target image and the hue information of the target image, to obtain the color feature of the target image.

The RGB value of the pixel is an RGB value of each pixel of the image. Usually, the color value of each pixel may be represented by three bytes, respectively characterizing values of components of three primary colors red, green, and blue, and the three primary colors form all true color effects. The three components R, G, and B are usually referred to as three independent color channels, and a range of a value of each color channel is [0, 255]. A combination of different values of the three channels may represent different colors, as shown in FIG. 4. For example, RGB (255, 0, 0) represents red, RGB (0, 255, 0) represents green, RGB (0, 0, 255) represents blue, RGB (255, 255, 0) represents yellow, RGB (255, 0, 255) represents purple, RGB (0, 255, 255) represents cyan, RGB (255, 255, 255) represents white, and RGB (0, 0, 0) represents black.

The hue information is relative lightness level information of the image, and is represented as corresponding color information for a color image. In this embodiment, the hue information of the target image is configured for characterizing an overall color of the target image, for example, a white hue, a dark hue, or a stray hue. Usually, when a color occupies a maximum quantity of pixels of an image, the color may be used as hue information of the image. In addition, because the RGB value of each pixel may represent a corresponding color, the hue information of the target image may be determined based on the distribution of the RGB value of the pixel of the target image. For example, a color of a pixel having a largest RGB value distribution may be determined as the hue information of the target image.

Lightness is lightness of a color, and is visual experience determined by a light intensity. Generally, a higher light intensity indicates a brighter color and higher lightness, and a lower light intensity indicates a darker color and lower lightness. Lightness 0 indicates pure black (in this case, the color is the darkest). Usually, a lightness value of each pixel may be obtained by converting an RGB value of the corresponding pixel.

Specifically, calculation may be performed for RGB-to-lightness conversion by using the following formula:

$$L = \sqrt[2.2]{\frac{{( \frac{R}{255} )}^{2.2} + {( 1.5 \times \frac{G}{255} )}^{2.2} + {( 0.6 \times \frac{B}{255} )}^{2.2}}{1 + {1.5}^{2.2} + {0.6}^{2.2}}}$$

R, G, and B respectively correspond to components of three color channels of the pixel, and L indicates lightness of the corresponding pixel, and has a value ranging from 0 to 1.

After the lightness of each pixel of the target image is obtained through foregoing conversion, an overall lightness value of the target image may be calculated statistically. For example, the lightness of each pixel of the target image is averaged, and an average value may be used as the overall lightness value of the target image. Alternatively, the lightness value of each pixel of the target image is sorted, a median is determined, and the median may be used as the overall lightness value of the target image.

Constructing the color feature vector of the target image may specifically combining the lightness value of the target image and the hue information of the target image to obtain the color feature vector. The color feature vector may be used as the color feature of the target image.

In this embodiment, the computer device may obtain the RGB value of the pixel of the target image, and determine the hue information of the target image based on the RGB value distribution of the pixel of the target image. The computer device may further convert the RGB value of the pixel of the target image into the lightness value of the target image, and constructs the color feature vector of the target image based on the lightness value of the target image and the hue information of the target image, to obtain the color feature of the target image. In this embodiment, the target image is acquired in real time, the RGB value of the pixel of the target image is obtained, and then the hue information of the target image is determined based on the RGB value distribution of the pixel of the target image, so that accurate hue information can be obtained. The lightness value of the target image is determined based on the RGB value of the pixel of the target image, and then the lightness value of the target image and the hue information of the target image are combined to obtain the constructed color feature vector of the target image, that is, obtain the color feature of the target image, so that the ambient light scenario of the acquisition environment corresponding to the target image can be reflected in real time, and the corresponding target environmental category can be determined based on the color feature of the target image. This can implement real-time determining of the category of the acquisition environment of the target image, improving accuracy of determining the category of the acquisition environment of the target image.

In an embodiment, the determining hue information of the target image based on an RGB value distribution of the pixel of the target image includes:
mapping the RGB value of the pixel of the target image to an RGB coordinate system; determining, based on a color space of a preset hue and the RGB value of the pixel of the target image, a target color space having a maximum quantity of pixels in the RGB coordinate system; and determining a hue corresponding to the target color space as the hue information of the target image.

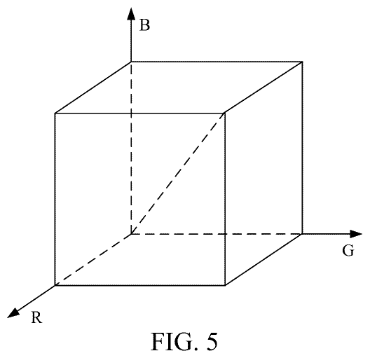

The RGB coordinate system is a three-dimensional coordinate system established by using the three channels, R, G, and B as coordinate axes. The three coordinate axes respectively represent values of the three channels R, G, and B. The values of the three channels R, G, and B range from 0 to 255. Therefore, each true color value belongs to any point in a three-dimensional cube space. FIG. 5 is a schematic diagram of the RGB coordinate system. The three-dimensional cube space is a range of the RGB coordinate system. It can be learned from the RGB coordinate system that pure black is located at a coordinate origin, pure white is located at a diagonal point of the origin, a color value on a diagonal line between pure black and pure white is a grayscale value, and a discrete point in another space directly represents a corresponding color. Therefore, the RGB value of the pixel of the target image may be mapped to the RGB coordinate system, that is, all RGB values of all pixels of the target image are filled into the three-dimensional cube space.

A color space is also referred to as a “color gamut”. In coloristics, one-dimensional, two-dimensional, three-dimensional, or four-dimensional space coordinates are used to represent a color in the color space, and a color range that can be defined by such coordinates is the color space. The color space of the preset hue represents a space coordinate range of a color corresponding to the preset hue. In this embodiment, there may be a plurality of color spaces of preset hues, which respectively represent different hues or colors. The target color space is a finally determined color space having the maximum quantity of pixels. Specifically, after the RGB values of all the pixels of the target image are filled into the foregoing three-dimensional cube space, the color space of each preset hue may be moved from a vertex of the RGB coordinate system, and statistics on a quantity of pixels falling within the color space of each preset hue is collected. The color space of each preset hue is moved to traverse the RGB coordinate system, to obtain a color space having the maximum quantity of pixels, that is, obtain the target color space. Further, the hue corresponding to the target color space may be determined as the hue information of the target image. The hue corresponding to the target color space may be a preset hue corresponding to the color space.

In this embodiment, the computer device maps the RGB value of the pixel of the target image to the RGB coordinate system, determines, based on the color space of the preset hue and the RGB value of the pixel of the target image, the target color space having the maximum quantity of pixels in the RGB coordinate system, and determines the hue corresponding to the target color space as the hue information of the target image. In this way, the hue information of the target image can be determined quickly and accurately.

In an embodiment, the color feature of the target image includes the lightness value of the target image and the hue information of the target image. The recognizing, based on the color feature of the target image, a target environmental category corresponding to the target image may include:
determining that the target environmental category corresponding to the target image is a dim light category if the lightness value of the target image is less than a preset first threshold and the hue information of the target image matches a preset first hue, the first hue being configured for characterizing hue information corresponding to an image of the dim light category; determining that the target environmental category corresponding to the target image is a white light category if the lightness value of the target image is greater than a preset second threshold and the hue information of the target image matches a preset second hue, the second threshold being greater than or equal to the first threshold, and the second hue being configured for characterizing hue information corresponding to an image of the white light category; and determining that the target environmental category corresponding to the target image is a stray light category if the hue information of the target image does not match the preset first hue and does not match the preset second hue.

The dim light category, the white light category, and the stray light category may be preset environmental categories. During an actual application, more categories or fewer categories may be set.

The first hue is a color space, that is, hue information, based on a hue corresponding to an image acquired in an environment of the dim light category. The color space of the hue may be set by experience, or may be obtained based on an experiment. For example, the color space of the hue may be determined based on a distribution of a hue of the image acquired in the environment of the dim light category. The environment of the dim light category may be an environment with a low light intensity, for example, may be an environment with a light intensity less than a minimum intensity required for normally shooting an image. The first threshold may be determined based on a distribution of a lightness value of the image acquired in the environment of the dim light category, or may be a preset empirical value. For example, the first threshold may be a median of a lightness range, or any value less than the median. When the lightness range is 0 to 1, the first threshold may be a value less than or equal to 0.5.

Specifically, when the computer device determines that the lightness value of the target image is less than the preset first threshold, and the hue information of the target image matches the preset first hue, it may be determined that the target environmental category corresponding to the target image is the dim light category.

Similarly, the second hue is a color space, that is, hue information, based on a hue corresponding to an image acquired in an environment of the white light category. The color space of the hue may be set by experience, or may be obtained based on an experiment, For example, the color space of the hue may be determined based on a distribution of a hue of the image acquired in the environment of the white light category. The environment of the white light category may be an environment that has a normal light intensity (that is, the light intensity is within a range required for normal image acquisition) and in which ambient light is white light. The second threshold may be determined based on a distribution of a lightness value of the image acquired in the environment of the white light category, or may be a preset empirical value. The second threshold is generally greater than or equal to the first threshold. For example, the second threshold may be the median of the lightness range, or any value greater than the median. When the lightness range is 0 to 1, the second threshold may be a value greater than or equal to 0.5.

Specifically, when the computer device determines that the lightness value of the target image is greater than the preset second threshold, and the hue information of the target image matches the preset second hue, it may be determined that the target environmental category corresponding to the target image is the white light category.

The stray light category is a category of a lamp light environment with various colors (for example, red, orange, yellow, green, cyan, blue, and purple). In this embodiment, a stray light environment may alternatively be all other environments other than a white light environment and a dim light environment.

Specifically, when the computer device determines that the hue information of the target image does not match the preset first hue and does not match the preset second hue, it may be determined that the target environmental category corresponding to the target image is the stray light category.

In the foregoing embodiment, the computer device determines, based on the lightness value of the target image and the hue information of the target image, the target environmental category corresponding to the target image. To be specific, when the lightness value of the target image is less than the preset first threshold, and the hue information of the target image matches the preset first hue, it is determined that the target environmental category corresponding to the target image is the dim light category; when the lightness value of the target image is greater than the preset second threshold, and the hue information of the target image matches the preset second hue, it is determined that the target environmental category corresponding to the target image is the white light category; and when the hue information of the target image does not match the preset first hue and does not match the preset second hue, it is determined that the target environmental category corresponding to the target image is the stray light category. The target environmental category corresponding to the target image is accurately determined based on a relationship between the lightness value of the target image and the first threshold and the second threshold of the lightness value and a relationship between the hue information of the target image and the preset first hue and second hue.

In an embodiment, after the determining that the target environmental category corresponding to the target image is the stray light category, the method may further include: determining, based on the hue information of the target image, a color category matching the hue information, the color category including any one of a red category, an orange category, a yellow category, a green category, a cyan category, a blue category, and a purple category; and determining the color category as a subcategory under the target environmental category corresponding to the target image.

The stray light category is a category of a lamp light environment with various colors (for example, red, orange, yellow, green, cyan, blue, and purple), and color features presented by images in lamp light environments of different colors are different. Therefore, the stray light category may be further subdivided into subcategories of different colors.

Specifically, in this embodiment, when determining that the target environmental category corresponding to the target image is the stray light category, the computer device may further determine, based on the hue information of the target image, a color category corresponding to the target image, and use the color category as the subcategory under the target environmental category corresponding to the target image, to further subdivide the stray light category into subcategories of different colors, and further perform matching between each subcategory and a corresponding target identity recognition algorithm, to further improve accuracy of image recognition in the stray light category.

In an embodiment, the recognizing, based on the color feature of the target image, a target environmental category corresponding to the target image may further include:
inputting the color feature of the target image to a pre-obtained image classification model to obtain the target environmental category that is outputted by the image classification model and that corresponds to the target image, the image classification model being obtained through training based on a color feature and an environmental category label of a sample image, different environmental category labels being configured for characterizing different ambient light scenarios, and the color feature of the sample image being at least configured for characterizing ambient chromaticity information of an ambient light scenario corresponding to the sample image.

The image classification model may classify target images having different color features into different environmental categories. The image classification model may be a model predefined by the computer device, or a model obtained by the computer device based on machine learning, or a model obtained based on deep learning.

In a scenario, the image classification model may be a model predefined or obtained through learning by the server, and the server may further update the image classification model and distribute an updated image classification model to the terminal. The terminal may receive the image classification model from the server, and predict, based on the image classification model, the target environmental category corresponding to the target image. Therefore, efficiency of recognizing the target environmental category corresponding to the target image is improved.

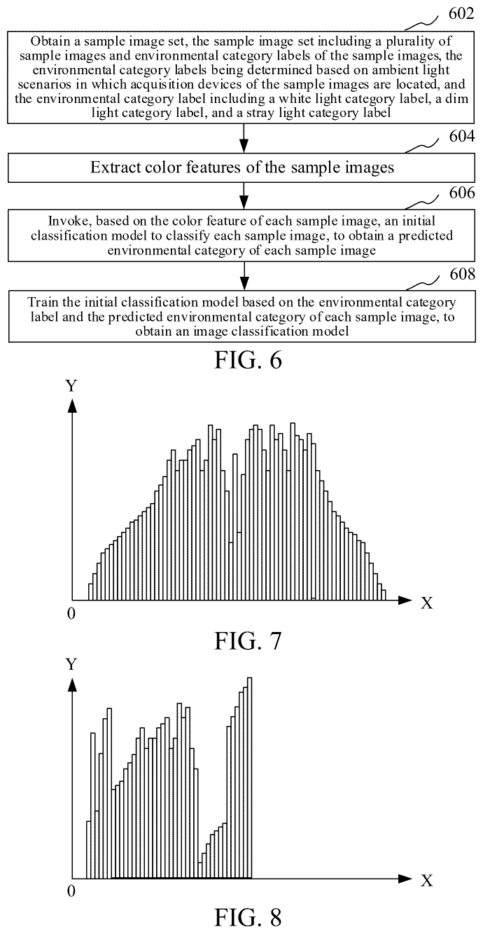

In an embodiment, as shown in FIG. 6, a method for obtaining the image classification model includes the following operations.

Operation 602: Obtain a sample image set, the sample image set including a plurality of sample images and environmental category labels of the sample images, the environmental category labels being determined based on ambient light scenarios in which acquisition devices of the sample images are located, and the environmental category label including a white light category label, a dim light category label, and a stray light category label.

The sample image set includes the plurality of sample images. Each sample image has a corresponding environmental category label. The environmental category label is a label of an actual environmental category of the sample image that is determined based on the ambient light scenario in which the image acquisition device of the sample image is located. The ambient light scenario may be a light intensity related scenario, a light color related scenario, or the like in an environment. Specifically, the environmental category label may include the white light category label, the dim light category label, and the stray light category label.

In an embodiment, the stray light category label may be further subdivided into subcategory labels of different colors, for example, a red subcategory label, an orange subcategory label, a yellow subcategory label, a green subcategory label, a cyan subcategory label, a blue subcategory label, and a purple subcategory label.

Operation 604: Extract a color feature of the sample image.

The color feature of the sample image is at least configured for characterizing ambient chromaticity information corresponding to the sample image. The color feature of the sample image has a same meaning as the color feature of the target image, and is extracted in a same manner as the color feature of the target image. Details are not described in this embodiment again.

Operation 606: Invoke, based on the color feature of each sample image, an initial classification model to classify each sample image, to obtain a predicted environmental category of each sample image.

The initial classification model may be implemented by using a support vector machine (SVM), a random forest, a deep learning model (for example, a convolutional neural network), or the like.

The predicted environmental category is a classification result obtained by classifying the sample image by using the initial classification model. In this embodiment, the computer device may use the color feature of the sample image as an input of the initial classification model, to obtain the predicted environmental category that is outputted by the initial classification model and that corresponds to the sample image.

Operation 608: Train the initial classification model based on the environmental category label and the predicted environmental category of each sample image, to obtain the image classification model.

Training is a process of adjusting a model parameter by learning a large amount of data, so that the model has a capability of accurately predicting unknown data. The environmental category label is the label of the actual environmental category of the sample image, and the predicted environmental category is the classification result obtained by classifying the sample image by using the initial classification model. Therefore, a model loss may be determined based on the environmental category label and the predicted environmental category of the sample image, and then a model parameter of the initial classification model is adjusted based on the model loss until a convergence condition is satisfied, to obtain the image classification model.

In this embodiment, the sample image set is obtained, the color features of the sample images are extracted, the initial classification model is invoked based on the color features of the sample images, to classify each sample image to obtain the predicted environmental category of each sample image, and the initial classification model is trained based on the environmental category label and the predicted environmental category of each sample image, to obtain the image classification model. Because the image classification model is obtained by training the initial classification model based on the color features and the environmental category labels of the sample images, the image classification model obtained through training can learn color features of images under various environmental categories and accurately determine the environmental category of the target image through classification based on the color feature of the target image. Therefore, the efficiency of recognizing the environmental category corresponding to the target image can be improved.

Further, after the initial classification model is trained based on the environmental category label and the predicted environmental category of each sample image, indicators such as accuracy, precision, and recall of the trained model may be further evaluated by using a test data set, to determine performance of the model. In other words, after the model parameter of the initial classification model is adjusted based on the model loss, to satisfy the convergence condition, the indicators such as the accuracy, the precision, and the recall of the trained model that satisfies the convergence condition may be further evaluated by using the test data set, to determine the performance of the model. If the performance of the model meets a requirement, training is stopped to obtain the image classification model; or if the performance of the model does not meet the requirement, the training process shown in FIG. 6 is continued, and when the performance of the model meets the requirement, training is stopped. Therefore, reliability of the model is improved.

In an embodiment, the target image is acquired by using a corresponding image acquisition device. After the extracting a color feature of the target image, the method further includes:
determining, based on the color feature of the target image, whether there is ambient light interference in the target image; returning, when it is determined that there is the ambient light interference in the target image, an application adjustment parameter for the ambient light interference to the image acquisition device corresponding to the target image, to indicate a target image acquisition device to perform parameter adjustment based on the application adjustment parameter, the application adjustment parameter including at least one of a shutter speed parameter, a sensitivity parameter, an exposure time parameter, a white balance parameter, and a filtering parameter; and further obtaining a target image re-acquired by the image acquisition device adjusted based on the application adjustment parameter, and extracting a color feature of the re-acquired target image.

The ambient light interference is impact of light disturbance in the environment. Existence of the ambient light interference in the target image refers to a case in which image quality is damaged due to the impact of the light disturbance in the environment. Specifically, ambient light interference includes but is not limited to interference of the light intensity, interference of the light color, and the like.

The application adjustment parameter is a parameter for adjusting a related configuration in the target image acquisition device. For example, a shutter speed may be adjusted, sensitivity may be adjusted, exposure time may be adjusted, a color temperature may be adjusted to achieve a white balance, and a color of a filter may be adjusted.

The ambient light interference affects the image quality. When the ambient light interference is severe, the image quality is seriously damaged. Consequently, an environmental category corresponding to an image cannot be accurately recognized. The image quality may be usually determined based on a color feature of the image. Based on this, after extracting the color feature of the target image, the computer device may determine, based on the color feature of the target image, whether there is the ambient light interference in the target image, and return, when determining that there is the ambient light interference in the target image, the application adjustment parameter for the ambient light interference to the image acquisition device corresponding to the target image, so that the target image acquisition device performs parameter adjustment based on the application adjustment parameter, to reduce or eliminate the ambient light interference and improve image quality of a subsequently acquired image. Further, the target image re-acquired by the image acquisition device adjusted based on the application adjustment parameter is obtained, the target environmental category corresponding to the target image is recognized based on the color feature of the re-acquired target image, then a target identity recognition algorithm matching the re-acquired target image is obtained based on the target environmental category, and identity recognition is performed on the re-acquired target image based on the target identity recognition algorithm, to obtain the identity recognition result of the to-be-recognized object. In this way, an identity recognition failure caused by an image quality problem is avoided.

Specifically, the determining, based on the color feature of the target image, whether there is ambient light interference in the target image may further include:
obtaining brightness information and color noise of the target image based on the color feature of the target image, the brightness information of the target image including an overall brightness parameter of the target image or a brightness distribution of the pixel of the target image; and determining that there is the ambient light interference in the target image if the overall brightness parameter of the target image is less than a preset brightness threshold; determining that there is the ambient light interference in the target image if the brightness distribution of the pixel of the target image is not a target distribution; or determining that there is the ambient light interference in the target image if the color noise of the target image is greater than or equal to a preset color noise threshold.

The overall brightness parameter of the target image may be an overall brightness value of the target image, and may be obtained by collecting statistics on brightness of each pixel of the target image. Brightness of an image is usually related to an amount of light reflected by a color on a surface of an object. A larger amount of light reflected from a surface of a color object indicates higher brightness. Usually, a brightness value of each pixel may be obtained by converting the RGB value of the corresponding pixel.

Specifically, calculation may be performed for RGB-to-brightness conversion by using the following formula:

$$b = 0.299 \times R + 0.587 \times G + 0.114 \times B$$

R, G, and B respectively correspond to the components of the three color channels of the pixel, and b indicates brightness of the corresponding pixel, and has a value ranging from 0 to 255.

After the brightness of each pixel of the target image is obtained through foregoing conversion, the overall brightness value of the target image may be calculated statistically. For example, the brightness of each pixel of the target image is averaged, and an average value may be used as the overall brightness value of the target image. Alternatively, the brightness value of each pixel of the target image is sorted, a median is determined, and the median may be used as the overall brightness value of the target image.

In an embodiment, the identity recognition method further includes: determining, based on a color feature of an environmental image, whether there is ambient light interference in the environmental image, the environmental image being acquired by a corresponding image acquisition device; returning, when it is determined that there is the ambient light interference in the environmental image, an application adjustment parameter for the ambient light interference to the image acquisition device corresponding to the environmental image, to indicate the image acquisition device to perform parameter adjustment based on the application adjustment parameter; and obtaining an environmental image re-acquired by the image acquisition device adjusted based on the application adjustment parameter, and extracting a color feature of the re-acquired environmental image. In this embodiment, when it is determined that there is the ambient light interference, the image acquisition device is adjusted to re-acquire the environmental image, so that an environmental image with better quality can be obtained, ensuring accuracy of a final identity recognition result, and avoiding resource waste caused by the identity recognition failure.

In an embodiment, the determining, based on a color feature of an environmental image, whether there is ambient light interference in the environmental image includes: obtaining brightness information and color noise of the environmental image based on the color feature of the environmental image, the brightness information including an overall brightness parameter of the environmental image or a brightness distribution of a pixel of the environmental image; and determining that there is the ambient light interference in the environmental image when the overall brightness parameter of the environmental image is less than the preset brightness threshold, the brightness distribution of the pixel of the environmental image is not the target distribution, or the color noise of the environmental image is greater than or equal to the preset color noise threshold.

In a scenario, when the overall brightness parameter of the target image is less than the preset brightness threshold, it may be determined that there is the ambient light interference in the target image. The preset brightness threshold may be determined based on minimum brightness that needs to be reached when the image quality meets the requirement. To be specific, when overall brightness of the target image is less than the minimum brightness, it may be determined that there is the ambient light interference in the target image. In other words, it may be determined that the acquisition environment corresponding to the target image has inadequate light. Therefore, the application adjustment parameter for adjusting ambient light may be returned to the image acquisition device corresponding to the target image. For example, a parameter for reducing the shutter speed may be returned to the image acquisition device corresponding to the target image, a parameter for increasing the sensitivity may be returned to the image acquisition device corresponding to the target image, or a parameter for prolonging the exposure time may be returned to the image acquisition device corresponding to the target image, to compensate for the ambient light, to resolve the problem of deficiency of ambient light.

The brightness distribution of the pixel of the target image may be obtained by collecting statistics on the brightness of each pixel of the target image. Specifically, statistics on the brightness of each pixel of the target image may be collected to obtain a brightness distribution histogram shown in FIG. 7. A horizontal axis X represents a brightness range, that is, 0 to 255, and a vertical axis Y represents a quantity of pixels of the target image with specific brightness. When a quantity of pixels at a specific brightness level is large, a corresponding peak value is high.

The target distribution may be specifically a normal distribution, which is also referred to as a normal distribution. In other words, in a normal state, an ordinary object conforms to such a distribution rule. Usually, whether there is overexposure or underexposure can be learned from a brightness histogram. Generally, when the brightness histogram obeys the normal distribution (as shown in FIG. 7), there is no overexposure or underexposure, that is, exposure is normal. In this case, it may be determined that there is no ambient light interference in the target image. Therefore, an application parameter of the image acquisition device corresponding to the target image does not need to be adjusted.

However, when the pixels are mainly concentrated on the left of the brightness histogram, for example, in a state shown in FIG. 8, the corresponding image has an underexposure problem, that is, brightness of the image is excessively low. In this case, it may be determined that there is the ambient light interference in the target image. Therefore, the application adjustment parameter for adjusting the ambient light may be returned to the image acquisition device corresponding to the target image. For example, the parameter for reducing the shutter speed may be returned to the image acquisition device corresponding to the target image, the parameter for increasing the sensitivity may be returned to the image acquisition device corresponding to the target image, or the parameter for prolonging the exposure time may be returned to the image acquisition device corresponding to the target image, to compensate for the ambient light, to resolve the problem of image underexposure.

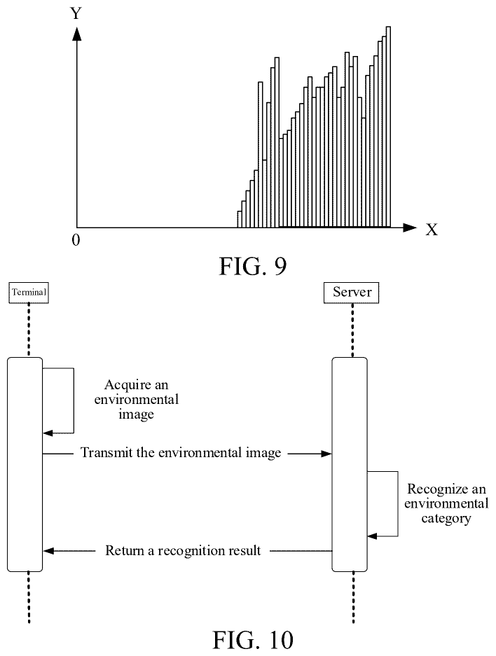

However, when pixels are mainly concentrated on the right of the brightness histogram, for example, in a state shown in FIG. 9, the corresponding image has an overexposure problem, that is, brightness of the image is excessively high. In this case, it may be determined that there is the ambient light interference in the target image. Therefore, the application adjustment parameter for adjusting the ambient light may be returned to the image acquisition device corresponding to the target image. For example, a parameter for increasing the shutter speed may be returned to the image acquisition device corresponding to the target image, a parameter for reducing the sensitivity may be returned to the image acquisition device corresponding to the target image, or a parameter for shortening the exposure time may be returned to the image acquisition device corresponding to the target image, to reduce the ambient light, to resolve the problem of image overexposure.

The color noise of the target image is noise of a picture in the image caused by light interference in the acquisition environment corresponding to the target image. The color noise may be determined based on an RGB value of a hue in the target image. Specifically, the RGB value of the hue may be determined based on RGB values of all pixels in a color space corresponding to the hue. For example, the RGB value of the hue may be an average value or a median of the RGB values of all the pixels in the color space corresponding to the hue.

The color noise threshold may be a preset RGB threshold of a corresponding hue. Therefore, when an RGB value of a hue in the target image is greater than or equal to an RGB threshold of the hue, chromaticity of the hue in the target image is excessively high, so that it may be determined that there is the ambient light interference in the target image. Therefore, the application adjustment parameter for the ambient light interference may be returned to the image acquisition device corresponding to the target image. Specifically, a proper filter may be selected based on a specific color of the hue with excessively high chromaticity in the target image, to filter out unwanted light. For example, when the hue with excessively high chromaticity in the target image is blue, blue light in the environment may be filtered out by using a yellow filter, to improve the quality of the subsequently acquired image.

In a scenario, to truly reproduce a color of an object on site, a color temperature of the image acquisition device may be usually adjusted based on light on a shooting site, that is, white balance adjustment is performed. When the color temperature on site is lower than a color temperature set by a built-in program, a shot image is reddish. When the color temperature on site is higher than the color temperature set by the program, the shot image is blueish. Therefore, in this embodiment, a white balance evaluation parameter of the target image may be obtained based on the color feature of the target image. The white balance evaluation parameter represents a magnitude relationship between an ambient color temperature of the environment in which the image acquisition device is located and a built-in color temperature of the image acquisition device. For example, when it is determined, based on the color feature of the target image, that an overall hue of the target image is blue, the built-in color temperature of the corresponding target image acquisition device is excessively low. Therefore, it may be determined that there is the ambient light interference in the target image, and an application adjustment parameter for increasing the built-in color temperature may be returned to the image acquisition device corresponding to the target image, to achieve the white balance. When it is determined, based on the color feature of the target image, that the overall hue of the target image is red, the built-in color temperature of the corresponding target image acquisition device is excessively high. Therefore, it may be determined that there is the ambient light interference in the target image, and an application adjustment parameter for reducing the built-in color temperature may be returned to the image acquisition device corresponding to the target image, to achieve the white balance.

In an embodiment, the target image is acquired by using the target image acquisition device. The target image carries a device identifier of the target image acquisition device. The device identifier may be a mark for distinguishing between different devices, and may be specifically a device identification code. In this case, the recognizing a target environmental category corresponding to the target image may further include:
determining, based on a pre-established matching relationship between a device identifier of an image acquisition device and an environmental category, an environmental category matching the device identifier of the target image acquisition device, and determining the environmental category matching the device identifier of the target image acquisition device as the target environmental category corresponding to the target image, the matching relationship between the device identifier of the image acquisition device and the environmental category being a matching relationship established between the device identifier and an environmental category determined based on a color feature of an ambient light scenario of an environment in which the image acquisition device is located.

Because the image acquisition device has a fixed deployment scenario, and when the image acquisition device is deployed in a scenario, an environmental category corresponding to the scenario is also fixed. Therefore, after an image acquisition device is deployed, a correspondence between a device identifier of the image acquisition device and an environmental category of a deployment scenario of the image acquisition device may be established. Then, all images acquired by the image acquisition device may be processed based on the environmental category corresponding to the image acquisition device. Therefore, efficiency of recognizing the target environmental category corresponding to the target image is improved.

In an embodiment, the matching relationship between the device identifier of the image acquisition device and the environmental category may be specifically established by using the following method:
obtaining an environmental image acquired by the image acquisition device; extracting a color feature of the environmental image, the color feature of the environmental image being at least configured for characterizing ambient chromaticity information of an ambient light scenario corresponding to the environmental image; determining, based on the color feature of the environmental image, an environmental category corresponding to the environmental image; and establishing a matching relationship between the environmental category corresponding to the environmental image and the device identifier of the image acquisition device.

The environmental image acquired by the image acquisition device may be an environmental image acquired by the image acquisition device during initialization. Initialization may be startup logic during first startup of the terminal after the terminal is deployed. Alternatively, initialization may be startup logic when the terminal is powered on again after the terminal is powered off. For example, during first startup after the terminal is deployed, the terminal may invoke the image acquisition device to acquire the environmental image. Therefore, the environmental category of the environment in which the image acquisition device is located may be determined based on the acquired environmental image.

The environmental image acquired by the image acquisition device may alternatively be an environmental image acquired when an ambient light scenario of an environment in which the image acquisition device is located changes. For example, a light intensity of an on-site environment may be monitored by using the image acquisition device. For another example, a light intensity or another environmental information of an on-site environment may be monitored by using a light sensor. Therefore, when it is monitored that the ambient light scenario of the environment in which the image acquisition device is located changes, the image acquisition device may be triggered to acquire a corresponding environmental image, to redetermine, based on the acquired environmental image, an environmental category of the environment in which the image acquisition device is located.

Specifically, to ensure accuracy of environmental image-based classification, there may be a plurality of environmental images. For example, during environmental image acquisition, the image acquisition device may acquire a plurality of (for example, five) environmental images at a specific time interval, to improve the accuracy of environmental image-based classification.

The color feature of the environmental image has a same meaning as the color feature of the target image, and is extracted in a same manner as the color feature of the target image. In addition, a manner for determining the environmental category corresponding to the environmental image is also similar to the foregoing manner for determining the environmental category corresponding to the target image. For example, the environmental category corresponding to the environmental image may be determined based on the color feature such as a lightness value and hue information of the environmental image, or the environmental category corresponding to the environmental image may be determined based on the pre-obtained image classification model. Details are not described in this embodiment again.

In this embodiment, establishing the matching relationship between the device identifier of the image acquisition device and the environmental category may be locally performed by the terminal. For example, the terminal may invoke, when monitoring that the ambient light scenario changes, the image acquisition device to acquire the environmental image, or the terminal may invoke, during initialization, the image acquisition device to acquire the environmental image, further extract the color feature of the environmental image, determine, based on the color feature of the environmental image, the environmental category corresponding to the environmental image, and establish the matching relationship between the environmental category corresponding to the environmental image and the device identifier of the image acquisition device. All images acquired by the image acquisition device are subsequently processed based on the corresponding environmental category.

In an embodiment, as shown in FIG. 10, establishing the matching relationship between the device identifier of the image acquisition device and the environmental category may alternatively be performed on the server. The terminal may invoke, when monitoring that the ambient light scenario changes or during initialization, the image acquisition device to acquire the environmental image. The terminal transmits the acquired environmental image to the server. The server extracts the color feature of the environmental image, determines, based on the color feature of the environmental image, the environmental category corresponding to the environmental image, and establishes the matching relationship between the environmental category corresponding to the environmental image and the device identifier of the image acquisition device. The server may further return the environmental category corresponding to the environmental image to the terminal. All images acquired by the image acquisition device may be subsequently processed based on the corresponding environmental category.

Further, in a process of establishing the matching relationship between the device identifier of the image acquisition device and the environmental category, whether there is the ambient light interference in the environmental image may be further determined based on the color feature of the environmental image, and when it is determined that there is the ambient light interference in the environmental image, the application adjustment parameter for the ambient light interference is returned to the image acquisition device corresponding to the environmental image, so that the image acquisition device may perform parameter adjustment based on the application adjustment parameter. Further, the environmental image acquired by the image acquisition device adjusted based on the application adjustment parameter is obtained, and the color feature of the re-acquired environmental image is extracted to determine, based on the color feature of the re-acquired environmental image, the environmental category of the image acquisition device. Therefore, accuracy of recognizing the environmental category of the image acquisition device is improved, to avoid a recognition error caused by the ambient light interference.

The process of determining whether there is the ambient light interference in the environmental image based on the color feature of the environmental image is similar to the foregoing process of determining whether there is the ambient light interference in the target image based on the color feature of the target image. Details are not described in this embodiment again.

In a scenario, the target image may include an infrared image and a color image. The infrared image may be specifically an infrared image that is acquired by an infrared sensor of the image acquisition device and that is obtained through pan-infrared imaging. The color image may be specifically a color image that is acquired by a color sensor of the image acquisition device and that is obtained through natural light imaging. The infrared image and the color image of the target image are images acquired from the same to-be-recognized object.

In an embodiment, the obtaining, based on the target environmental category, the target identity recognition algorithm matching the target image, and performing identity recognition on the target image based on the target identity recognition algorithm, to obtain an identity recognition result of the to-be-recognized object may include:
performing, if the target environmental category is the white light category, first recognition on the color image to obtain a first recognition result, and performing second recognition on the infrared image to obtain a second recognition result; and performing equal-weight weighted processing on the first recognition result and the second recognition result to obtain the identity recognition result of the to-be-recognized object.

First recognition may be a process of recognizing the color image of the target image and an image stored in a color image database. The color image database may be a database storing color images of all authorized users. For example, for the payment scenario, the color image database stores a color image of a user that has authorized image-based payment. For another example, for the attendance recording scenario, the color image database stores a color image of a user that has registered for image-based attendance recording. The first recognition result is a result obtained by recognizing the color image of the target image and the image stored in the color image database, for example, may be a similarity score between the color image of the target image and a target color image in the color image database. Specifically, the target color image may be an image having a highest similarity with the color image of the target image in the color image database.

Second recognition may be a process of recognizing the infrared image of the target image and an image stored in an infrared image database. Similarly, the infrared image database may be a database storing infrared images of all the authorized users. For example, for the payment scenario, the infrared image database stores an infrared image of the user that has authorized image-based payment. For another example, for the attendance recording scenario, the infrared image database stores an infrared image of the user that has registered for image-based attendance recording. The second recognition result is a result obtained by recognizing the infrared image of the target image and the image stored in the infrared image database, for example, may be a similarity score between the infrared image of the target image and a target infrared image in the infrared image database. The target infrared image and the target color image represent images of a same user.

Weighted processing is multiplying the recognition results by weight coefficients and then adding results. A sum of the weight coefficients is to be 1. Equal-weight weighted processing means weighted processing in which the weight coefficients are equal. Specifically, equal-weight weighted processing is performed on the first recognition result and the second recognition result to obtain the identity recognition result of the to-be-recognized object. In other words, weight coefficients of the first recognition result and the second recognition result are both 0.5.

In the white light scenario, both the infrared image and the color image have good image quality. Therefore, the infrared image and the color image may be recognized in a two-factor equal-weight manner, that is, equal-weight weighted processing is performed on the first recognition result obtained based on the infrared image and the second recognition result obtained based on the color image, to obtain a final identity recognition result of the to-be-recognized object. Therefore, security and accuracy of recognition can be ensured.

In an embodiment, the obtaining, based on the target environmental category, the target identity recognition algorithm matching the target image, and performing identity recognition on the target image based on the target identity recognition algorithm, to obtain an identity recognition result of the to-be-recognized object may further specifically include:
obtaining brightness of the color image if the target environmental category is the stray light category; determining a first recognition weight of the color image and a second recognition weight of the infrared image based on the brightness of the color image; performing first recognition based on the color image, to obtain the first recognition result, and performing second recognition based on the infrared image, to obtain the second recognition result; and obtaining the identity recognition result of the to-be-recognized object based on the first recognition result and the first recognition weight of the color image and the second recognition result and the second recognition weight of the infrared image.

The brightness of the color image may be obtained by performing conversion and statistics collection based on an RGB value of each pixel of the color image. In the stray light scenario, an excessively low light intensity may cause low-definition imaging of the color image, and the infrared image is not affected by ambient light due to use of a self-luminous source. Therefore, in this case, the recognition weight of the infrared image may be increased, and the recognition weight of the color image may be reduced.

In addition, a lower ambient light intensity indicates lower brightness and poorer imaging quality of the formed color image. Based on this, the first recognition weight of the color image and the second recognition weight of the infrared image may be determined based on the brightness of the color image. Specifically, a minimum brightness threshold is set, recognition weights respectively corresponding to the color image and the infrared image at the minimum luminance threshold are preset, and then the first recognition weight of the color image and the second recognition weight of the infrared image may be determined based on a relationship between the brightness of the color image and the minimum brightness threshold. For example, if the minimum brightness threshold is L1, it is preset that at the minimum brightness threshold, the recognition weight of the color image is 0.1 and the recognition weight of the infrared image is 0.9. In this case, if the brightness of the color image is less than or equal to the minimum brightness threshold L1, it may be determined that the first recognition weight of the color image of the target image is 0.1, and the second recognition weight of the infrared image is 0.9. If the brightness of the color image is greater than the minimum brightness threshold L1, based on a difference between the brightness of the color image and the minimum brightness threshold L1, the first recognition weight of the color image may be gradually increased, and the second recognition weight of the infrared image may be correspondingly reduced. For example, a brightness step 50 may be set to one level, and a corresponding weight step 0.1 may be set to one level. Therefore, a multiple relationship between the step 50 and the difference between the brightness of the color image and the minimum brightness threshold L1 may be calculated. When the multiple is 1, the first recognition weight of the color image is increased by 1×0.1, and the second recognition weight of the infrared image is reduced by 1×0.1. When the multiple is 2, the first recognition weight of the color image is increased by 2×0.1, and the second recognition weight of the infrared image is reduced by 2×0.1. A value of the second recognition weight of the infrared image shall not be less than 0.5. In other words, when the first recognition weight of the color image is increased to 0.5, the recognition weight corresponding to the color image is no longer increased no matter how high the brightness of the color image is. Therefore, the recognition accuracy can be ensured.

In an embodiment, the obtaining, based on the target environmental category, the target identity recognition algorithm matching the target image, and performing identity recognition on the target image based on the target identity recognition algorithm, to obtain an identity recognition result of the to-be-recognized object may further specifically include:
if the target environmental category is the dim light category, performing identity recognition on the infrared image to obtain the identity recognition result of the to-be-recognized object.

A lower ambient light intensity indicates lower brightness and poorer imaging quality of the formed color image. Therefore, when it is determined that the target environmental category of the target image is the dim light category, identity recognition may be performed by using only the infrared image, to obtain the identity recognition result of the to-be-recognized object. Because no reference is made to the color image, recognition interference caused by poor quality of the color image can be avoided.

In an embodiment, application of the foregoing method to a resource transfer scenario is used as an example. When obtaining a resource transfer request, the terminal may invoke the image acquisition device to acquire a target image of an object intended to perform resource transfer, recognize a target environmental category corresponding to the target image, obtain, based on the target environmental category, a target identity recognition algorithm matching the target image, and perform identity recognition on the target image based on the target identity recognition algorithm, to obtain an identity recognition result of the to-be-recognized object. Because different environmental categories correspond to different identity recognition algorithms, accuracy of identity recognition can be improved. When the identity recognition result indicates that identity recognition of the object intended to perform resource transfer succeeds, the terminal may further perform a resource transfer operation based on the resource transfer request, improving resource transfer efficiency.

Specifically, if the resource transfer scenario is face scanning payment, the image acquisition device may be configured to acquire a facial image of the object intended to perform resource transfer (that is, the to-be-recognized object). If the resource transfer scenario is palm scanning payment, the image acquisition device may be configured to acquire a palm image of the object intended to perform resource transfer (that is, the to-be-recognized object).

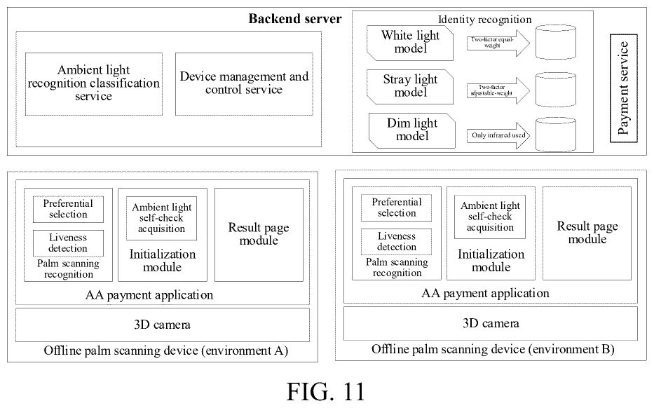

In an embodiment, application of the foregoing method to an identity recognition system shown in FIG. 11 is used as an example. The terminal may be an Internet of things payment device such as a merchant payment terminal or a palmprint payment terminal (for example, a palm scanning device), and may be deployed in various supermarkets and convenience stores. The terminal may be provided with a built-in image acquisition device (for example, a 3D camera). A payment application (for example, an AA payment application) may be further installed on the terminal. The server may be a backend server that provides a backend service support for the Internet of things payment device, and may specifically provide an ambient light recognition classification service, a terminal device management and control service, an identity recognition service, a payment service, and the like.

When deployment environments of different terminals are different (for example, a terminal A and a terminal B may be palmprint payment terminals deployed in different environments), or software and hardware configurations of terminals are different, imaging effects of images acquired by the terminals are also different. Therefore, definitions of images acquired by some terminals are high, definitions of images acquired by some terminals are low, brightness of images acquired by some terminals is excessively low, brightness of images acquired by some terminals is excessively high, and the like. If the backend server/service performs identity recognition processing on all images with different quality by using a same policy, accuracy of identity recognition is affected, and a recognition success rate is reduced.

Based on this, in this embodiment, when the terminal (the terminal A or the terminal B) is activated for the first time after deployed at a merchant store, initialization logic is performed. During initialization of the terminal, the terminal performs ambient light self-check collection, that is, invokes the 3D camera to acquire a current environmental image, and transmits the environmental image to the backend server/service. After receiving the environmental image from the terminal, the backend server/service may invoke an ambient light recognition classification service to recognize an environmental category of the environmental image. For example, the ambient light recognition classification service may extract a color feature of the environmental image, and determine the corresponding environmental category based on the extracted color feature; or may input, based on the preset image classification model, the acquired environmental image to the image classification model to obtain the environmental category that is outputted by the model and that corresponds to the acquired environmental image. Therefore, a speed of recognizing the environmental category of the environmental image is improved. On one hand, the backend server/service may manage and control the terminal in the terminal device management and control service based on the recognized environmental category, for example, record a correspondence between the environmental category and the corresponding terminal. On the other hand, the backend server/service may further return a recognition result of the environmental category to the corresponding terminal, so that the corresponding terminal may record the environmental category in a result page module.

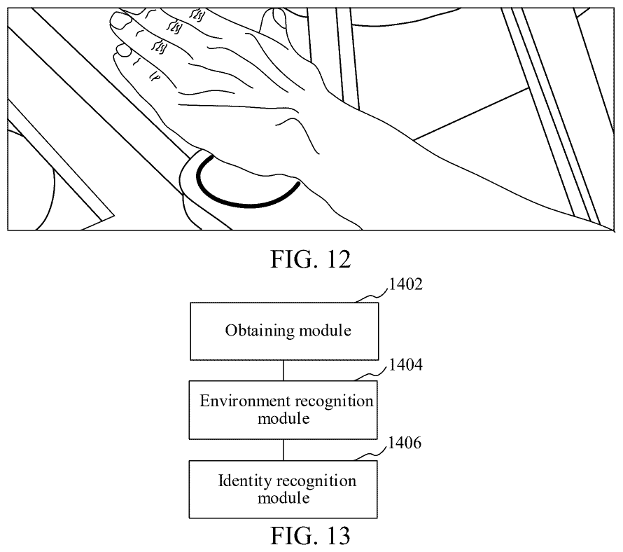

Later, during specific application, for example, a scenario of self-service payment in a supermarket with a palmprint payment terminal is used as an example. A user may add a commodity to a shopping list through code scanning on a payment terminal of the supermarket without a mobile phone or a wallet. Then, a payment is triggered by using an operation interface provided by the payment terminal, and the payment terminal invokes a 3D camera to acquire a target image (for example, a palm image, usually including an infrared image and a color image) of the user. An acquisition process is shown in FIG. 12. The payment terminal may transmit the acquired target image to the backend server/service, so that the backend server/service may determine, based on the correspondence that is recorded in the terminal device management and control service and that is between the terminal and the environmental category, the environmental category corresponding to the terminal acquiring the target image, and may further perform identity recognition on the target image by using a processing policy corresponding to the environmental category. For example, if it is determined that the environmental category is the white light category, identity recognition may be performed on the target image in the two-factor equal-weight manner (that is, recognition weights of the acquired infrared image and color image are equal), to obtain an identity recognition result of the user. If it is determined that the environmental category is the stray light category, identity recognition may be performed on the target image in a two-factor adjustable-weight manner (that is, recognition weights of the acquired infrared image and color image are adjustable), to obtain an identity recognition result of the user. If it is determined that the environmental category is the dim light category, identity recognition may be performed on the target image in a single-factor manner (that is, only the acquired infrared image is used), to obtain an identity recognition result of the user.

When the identity recognition result indicates that identity recognition of the user succeeds, the server may deduct money from an account of the user based on a to-be-paid amount, and pay the money to the merchant. In addition, the server may further return a payment details page to the payment terminal, to present payment details to the user. In this way, the user can perform secure payment through face scanning or palm scanning.

When acquiring the target image of the user, the 3D camera usually acquires a plurality of target images. The payment terminal may preferentially select a best target image (for example, having best image quality and a most complete feature region) from the plurality of acquired target images, and transmit the target image to the backend server/service.

In addition, to improve security of payment, a liveness detection service may be further set in the payment application of the payment terminal, that is, whether there is a living object in the target image is detected. Therefore, the payment terminal may further first perform liveness detection on the target image by using the liveness detection service, and transmit the target image to the backend server/service only when confirming that there is the living object in the target image.

In the foregoing embodiment, the environmental category of the image acquisition device is determined based on the environmental image acquired by the image acquisition device during initialization, and identity recognition processing is performed on all images acquired by the image acquisition device based on the corresponding environmental category, so that a processing speed of the system is improved. During an actual application, a target environmental category of the target image acquired during payment of the user may alternatively be determined based on the target image, ensuring accuracy of classifying the target image. Further, identity recognition processing is performed on the target image based on the target environmental category, improving recognition accuracy.

In the foregoing embodiment, when the target environmental category of the target image acquired during payment of the user may be determined based on the target image, the payment terminal may transmit the acquired target image of the user to the backend server/service. The backend server/service extracts the color feature of the target image by using the ambient light recognition classification service, and determines the corresponding environmental category based on the extracted color feature. The ambient light recognition classification service of the backend server/service may alternatively input the target image to the image classification model based on the preset image classification model, to obtain the target environmental category that is outputted by the model and that corresponds to the target image. Therefore, the speed of recognizing the environmental category of the image is improved.

In the foregoing embodiment, extracting a color feature of an image (for example, the target image or the environmental image) may specifically include: obtaining an RGB value of a pixel of the image; determining hue information of the image based on an RGB value distribution of the pixel of the image; converting the RGB value of the pixel of the image into a lightness value of the image; and constructing a color feature vector of the image based on the lightness value of the image and the hue information of the image, to obtain the color feature of the image. The determining the hue information of the image based on the RGB value distribution of the pixel of the image may specifically include: mapping the RGB value of the pixel of the image to the RGB coordinate system; determining, based on a color space of a preset hue and the RGB value of the pixel of the image, a target color space having a maximum quantity of pixels in the RGB coordinate system; and determining a hue corresponding to the target color space as the hue information of the image. In this way, the color feature of the image obtained based on the hue information can better express a corresponding ambient light scenario.

In an embodiment, application of the foregoing method to access control is used as an example. The terminal may be an access control terminal (for example, a palm scanning control terminal or a face scanning control terminal), and may be deployed at entrances and exits of various office buildings and factories. The access control terminal may be provided with a built-in image acquisition device (for example, a 3D camera). In this embodiment, the access control terminal and a corresponding server may jointly perform the foregoing identity recognition method to implement access control, or the access control terminal may perform the foregoing identity recognition method alone to implement access control.

Imaging effects of images acquired by the access control terminal in different ambient light scenarios are different. The access control terminal is usually deployed at various entrances and exits, and is easily affected by natural illumination. For example, overexposed imaging may be caused in sunny weather with strong ultraviolet light, and underexposed imaging may be caused in rainy weather or at night. If identity recognition processing is performed on all images with different quality by using a same policy, accuracy of identity recognition is affected, and a recognition success rate is reduced, leading to congestion at the entrances or exits.

Based on this, in this embodiment, an example in which the access control terminal performs the foregoing identity recognition method alone to implement access control is used. Specifically, during a specific application, when a user does not carry an access card, the access control terminal may acquire a target image (for example, a facial image or a palm image) of the user, recognize a target environmental category of the target image, and further perform identity recognition on the target image by using a processing policy corresponding to the target environmental category. For example, if it is determined that the environmental category is the white light category, identity recognition may be performed on the target image in the two-factor equal-weight manner (that is, recognition weights of the acquired infrared image and color image are equal), to obtain an identity recognition result of the user. If it is determined that the environmental category is the stray light category, identity recognition may be performed on the target image in a two-factor adjustable-weight manner (that is, recognition weights of the acquired infrared image and color image are adjustable), to obtain an identity recognition result of the user. If it is determined that the environmental category is the dim light category, identity recognition may be performed on the target image in a single-factor manner (that is, only the acquired infrared image is used), to obtain an identity recognition result of the user.

When the identity recognition result indicates that identity recognition of the user succeeds, the access control terminal may unlock a door to allow the user to pass through based on the result indicating that identity recognition succeeds. When the identity recognition result indicates that identity recognition of the user does not succeed, the access control terminal does not unlock a door to allow the user to pass through. In this way, barrier-free access of the user can be implemented through face scanning or palm scanning.

In the foregoing embodiment, recognizing the target environmental category of the target image may be specifically extracting a color feature of the target image and determining the corresponding environmental category based on the extracted color feature. The extracting a color feature of the target image may specifically include: obtaining an RGB value of a pixel of the target image; determining hue information of the target image based on an RGB value distribution of the pixel of the target image; converting the RGB value of the pixel of the target image into a lightness value of the target image; and constructing a color feature vector of the target image based on the lightness value of the target image and the hue information of the target image, to obtain the color feature of the target image. Specifically, the determining hue information of the target image based on an RGB value distribution of the pixel of the target image may specifically include: mapping the RGB value of the pixel of the target image to the RGB coordinate system; determining, based on a color space of a preset hue and the RGB value of the pixel of the target image, a target color space having a maximum quantity of pixels in the RGB coordinate system; and determining a hue corresponding to the target color space as the hue information of the target image. In this way, the color feature of the target image obtained based on the hue information can better express a corresponding ambient light scenario.

In the foregoing embodiment, the access control terminal may further input the target image to the image classification model based on the preset image classification model, to obtain the target environmental category that is outputted by the model and that corresponds to the target image. Therefore, a speed of recognizing the environmental category of the target image is improved.

After the access control terminal is deployed in a scenario, a change of an ambient light scenario of the access control terminal is regular, and does not change in real time. Therefore, to improve recognition efficiency of recognizing the target environmental category of the target image, a correspondence between an access control terminal and a current environmental category may be further pre-established. For example, when monitoring that a current ambient light scenario changes, the access control terminal may acquire a corresponding environmental image, determine a corresponding current environmental category based on the currently acquired environmental image, then re-acquire a target image of the user, and process the target image based on the determined current environmental category. Therefore, a target environmental category of the target image does not need to be recognized in real time, helping reducing calculations of the access control terminal and improve the processing speed of the access control terminal.

In the foregoing embodiment, determining the corresponding current environmental category based on the currently acquired environmental image may be specifically extracting a color feature of the target image and determining the corresponding environmental category based on the extracted color feature, or may be inputting, based on the preset image classification model, the currently acquired environmental image to the image classification model to obtain the current environmental category that is outputted by the model and that corresponds to the currently acquired environmental image. Therefore, a speed of recognizing the environmental category of the currently acquired environmental image is improved.

In the foregoing embodiment, based on the color feature of the target image or the environmental image, whether there is ambient light interference in the corresponding image may be further determined. For example, brightness information and color noise of the image may be obtained based on the color feature of the image, the brightness information including an overall brightness parameter of the image or a brightness distribution of the pixel of the image. If the overall brightness parameter of the image is less than the preset brightness threshold, it may be determined that there is the ambient light interference in the image. Alternatively, if the brightness distribution of the pixel of the image is not the target distribution, it may be determined that there is the ambient light interference in the image. Alternatively, if the color noise of the image is greater than or equal to the preset color noise threshold, it may be determined that there is the ambient light interference in the image. When it is determined that there is the ambient light interference in the image, an application adjustment parameter for the ambient light interference may be further returned to a corresponding image acquisition device, to indicate the image acquisition device to perform parameter adjustment based on the application adjustment parameter, the application adjustment parameter including at least one of a shutter speed parameter, a sensitivity parameter, an exposure time parameter, a white balance parameter, and a filtering parameter. Further, an image re-acquired by the image acquisition device adjusted based on the application adjustment parameter is obtained, a color feature of the re-acquired image is extracted, and an environmental category corresponding to the re-acquired image is determined based on the color feature of the re-acquired image. Therefore, environmental category recognition accuracy is improved, to avoid a recognition error caused by the ambient light interference.

Although the operations in the flowchart in each of the foregoing embodiments are sequentially presented according to indications of arrowheads, these operations are not necessarily performed according to sequences indicated by the arrowheads. Unless otherwise explicitly specified in the present disclosure, execution of the operations is not strictly limited, and the operations may be performed in other sequences. Moreover, at least a part of the operations in each embodiment may include a plurality of operations or a plurality of stages. The operations or stages are not necessarily performed at the same moment but may be performed at different moments. The operations or stages are not necessarily performed in sequence, but may be performed alternately with other operations or at least a part of operations or stages of other operations.

Based on a same inventive concept, an embodiment of the present disclosure further provides an identity recognition apparatus for implementing the foregoing identity recognition method. An implementation solution provided by the apparatus for resolving the problem is similar to the implementation solution described in the foregoing method. Therefore, for specific definition of one or more embodiments of the identity recognition apparatus provided below, refer to the foregoing definition of the identity recognition method. Details are not described herein again.

In an embodiment, as shown in FIG. 13, an identity recognition apparatus is provided, including an obtaining module 1402, an environment recognition module 1404, and an identity recognition module 1406.

The obtaining module 1402 is configured to obtain a target image, the target image including an image formed from at least a part of a to-be-recognized object.

The environment recognition module 1404 is configured to extract a color feature of the target image, and recognize, based on the color feature of the target image, a target environmental category corresponding to the target image, different environmental categories being configured for characterizing different ambient light scenarios.

The identity recognition module 1406 is configured to obtain, based on the target environmental category, a target identity recognition algorithm matching the target image, and perform identity recognition on the target image based on the target identity recognition algorithm, to obtain an identity recognition result of the to-be-recognized object, different environmental categories corresponding to different identity recognition algorithms.

In an embodiment, the color feature of the target image is at least configured for characterizing ambient chromaticity information. The environment recognition module is further specifically configured to input the color feature of the target image to a pre-obtained image classification model to obtain the target environmental category that is outputted by the image classification model and that corresponds to the target image, the image classification model being obtained through training based on a color feature and an environmental category label of a sample image, different environmental category labels being configured for characterizing different ambient light scenarios, and the color feature of the sample image being at least configured for characterizing ambient chromaticity information of an ambient light scenario corresponding to the sample image.

In an embodiment, the environment recognition module is further specifically configured to: obtain an RGB value of a pixel of the target image; determine hue information of the target image based on an RGB value distribution of the pixel of the target image; convert the RGB value of the pixel of the target image into a lightness value of the target image; and construct a color feature vector of the target image based on the lightness value of the target image and the hue information of the target image, to obtain the color feature of the target image.

In an embodiment, the environment recognition module is further specifically configured to: map the RGB value of the pixel of the target image to an RGB coordinate system; determine, based on a color space of a preset hue and the RGB value of the pixel of the target image, a target color space having a maximum quantity of pixels in the RGB coordinate system; and determine a hue corresponding to the target color space as the hue information of the target image.

In an embodiment, the color feature of the target image includes the lightness value of the target image and the hue information of the target image. The environment recognition module is further specifically configured to determine that the target environmental category corresponding to the target image is a dim light category if the lightness value of the target image is less than a preset first threshold and the hue information of the target image matches a preset first hue, the first hue being configured for characterizing hue information corresponding to an image of the dim light category.

In an embodiment, the color feature of the target image includes the lightness value of the target image and the hue information of the target image. The environment recognition module is further specifically configured to determine that the target environmental category corresponding to the target image is a white light category if the lightness value of the target image is greater than a preset second threshold and the hue information of the target image matches a preset second hue, the second threshold being greater than or equal to the first threshold, and the second hue being configured for characterizing hue information corresponding to an image of the white light category.

In an embodiment, the color feature of the target image includes the lightness value of the target image and the hue information of the target image. The environment recognition module is further specifically configured to determine that the target environmental category corresponding to the target image is a stray light category if the hue information of the target image does not match the preset first hue and does not match the preset second hue.

In an embodiment, the environment recognition module is further specifically configured to: after determining that the target environmental category corresponding to the target image is the stray light category, determine, based on the hue information of the target image, a color category matching the hue information; and determine the color category as a subcategory under the target environmental category corresponding to the target image. The color category may include any one of a red category, an orange category, a yellow category, a green category, a cyan category, a blue category, and a purple category.

In an embodiment, the target image carries a device identifier of a target image acquisition device, and the target image is acquired by the target image acquisition device. The environment recognition module is further configured to determine, based on a pre-established matching relationship between a device identifier of an image acquisition device and an environmental category, an environmental category matching the device identifier of the target image acquisition device, and determine the environmental category matching the device identifier of the target image acquisition device as the target environmental category corresponding to the target image, the matching relationship between the device identifier of the image acquisition device and the environmental category being a matching relationship established between the device identifier and an environmental category determined based on a color feature of an ambient light scenario of an environment in which the image acquisition device is located.

In an embodiment, the environment recognition module is further specifically configured to: obtain an environmental image acquired by an image acquisition device, the image acquisition device having a corresponding device identifier; extract a color feature of the environmental image; input the color feature of the environmental image to the pre-obtained image classification model to obtain an environmental category that is outputted by the image classification model and that corresponds to the environmental image; and establish a matching relationship between the environmental category corresponding to the environmental image and the device identifier of the image acquisition device. The color feature of the environmental image is at least configured for characterizing ambient chromaticity information of an ambient light scenario corresponding to the environmental image.

In an embodiment, the obtaining module is further specifically configured to obtain an environmental image acquired by the image acquisition device during initialization, or obtain an environmental image acquired when an ambient light scenario of an environment in which the image acquisition device is located changes.

In an embodiment, the identity recognition apparatus further includes an interference adjustment module, configured to: determine, based on the color feature of the environmental image, whether there is ambient light interference in the environmental image, the environmental image being acquired by the corresponding image acquisition device; and return, when it is determined that there is the ambient light interference in the environmental image, an application adjustment parameter for the ambient light interference to the image acquisition device corresponding to the environmental image, to indicate the image acquisition device to perform parameter adjustment based on the application adjustment parameter, the application adjustment parameter including at least one of a shutter speed parameter, a sensitivity parameter, an exposure time parameter, a white balance parameter, and a filtering parameter.

The obtaining module 1402 is further configured to obtain an environmental image re-acquired by the image acquisition device adjusted based on the application adjustment parameter, and extract a color feature of the re-acquired environmental image.

In an embodiment, the interference adjustment module is further configured to: obtain brightness information and color noise of the environmental image based on the color feature of the environmental image, the brightness information including an overall brightness parameter of the environmental image or a brightness distribution of a pixel of the environmental image; and determine that there is the ambient light interference in the environmental image when the overall brightness parameter of the environmental image is less than a preset brightness threshold, the brightness distribution of the pixel of the environmental image is not target distribution, or the color noise of the environmental image is greater than or equal to a preset color noise threshold.

In an embodiment, the identity recognition apparatus further includes the interference adjustment module, configured to: determine, based on the color feature of the target image, whether there is ambient light interference in the target image, the target image being acquired by a corresponding image acquisition device; and return, when it is determined that there is the ambient light interference in the target image, an application adjustment parameter for the ambient light interference to the image acquisition device corresponding to the target image, to indicate the image acquisition device to perform parameter adjustment based on the application adjustment parameter, the application adjustment parameter including at least one of a shutter speed parameter, a sensitivity parameter, an exposure time parameter, a white balance parameter, and a filtering parameter.

The obtaining module 1402 is further configured to obtain a target image re-acquired by the image acquisition device adjusted based on the application adjustment parameter, and extract a color feature of the re-acquired target image.

In an embodiment, the interference adjustment module is further configured to: obtain brightness information and color noise of the target image based on the color feature of the target image, the brightness information of the target image including an overall brightness parameter of the target image or a brightness distribution of the pixel of the target image; and determine that there is the ambient light interference in the target image when the overall brightness parameter of the target image is less than the preset brightness threshold, the brightness distribution of the pixel of the target image is not the target distribution, or the color noise of the target image is greater than or equal to the preset color noise threshold.

In an embodiment, the environment recognition module is further configured to: obtain a sample image set, the sample image set including a plurality of sample images and environmental category labels of the sample images, the environmental category labels being determined based on ambient light scenarios in which acquisition devices of the sample images are located, and the environmental category label including a white light category label, a dim light category label, and a stray light category label; extract color features of the sample images, the color features of the sample images being at least configured for characterizing ambient chromaticity information corresponding to the sample images; invoke, based on the color feature of each sample image, an initial classification model to classify each sample image, to obtain a predicted environmental category of each sample image; and train the initial classification model based on the environmental category label and the predicted environmental category of each sample image, to obtain the image classification model.

In an embodiment, the target image includes an infrared image and a color image. The identity recognition module is further configured to: perform, if the target environmental category is the white light category, first recognition on the color image to obtain a first recognition result, and perform second recognition on the infrared image to obtain a second recognition result; and perform equal-weight weighted processing on the first recognition result and the second recognition result to obtain the identity recognition result of the to-be-recognized object.

In an embodiment, the target image includes the infrared image and the color image. The identity recognition module is further configured to: obtain brightness of the color image if the target environmental category is the stray light category; determine a first recognition weight of the color image and a second recognition weight of the infrared image based on the brightness of the color image; perform first recognition based on the color image, to obtain the first recognition result, and perform second recognition based on the infrared image, to obtain the second recognition result; and obtain the identity recognition result of the to-be-recognized object based on the first recognition result and the first recognition weight of the color image and the second recognition result and the second recognition weight of the infrared image.

In an embodiment, the target image includes the infrared image. The identity recognition module is further configured to: if the target environmental category is the dim light category, perform identity recognition on the infrared image to obtain the identity recognition result of the to-be-recognized object.

In an embodiment, when the apparatus is used in a server, the obtaining module is further configured to obtain the target image transmitted by a terminal device, the target image being acquired by the terminal device. The apparatus further includes a recognition result returning module, configured to return the identity recognition result of the to-be-recognized object to the terminal device after the identity recognition result of the to-be-recognized object is obtained.

In an embodiment, when the apparatus is used in a resource transfer scenario. The obtaining module is further configured to obtain a resource transfer request, and invoke an image acquisition device to acquire a target image of an object intended to perform resource transfer, the target image including a palm image of the object intended to perform resource transfer. The apparatus further includes a resource transfer module, configured to perform a resource transfer operation based on the resource transfer request when the identity recognition result indicates that identity recognition of the object intended to perform resource transfer succeeds.

Each module in the identity recognition apparatus may be implemented entirely or partially through software, hardware, or a combination thereof. Each module may be embedded in or independent of a processor in a computer device in a form of hardware, or may be stored in a memory in a computer device in a form of software, so that the processor may invoke the module to perform the operation corresponding to the module.

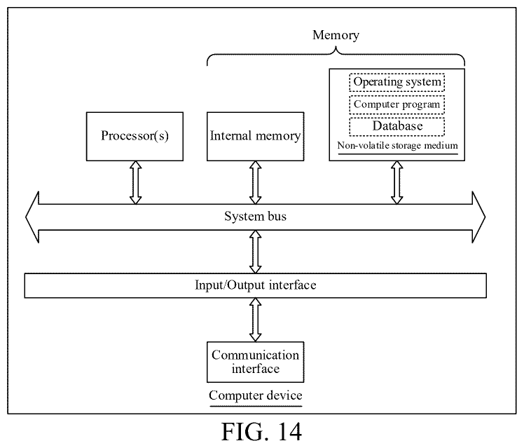

In an embodiment, a computer device is provided. The computer device may be a server or a terminal. A diagram of an internal structure of the computer device may be shown in FIG. 14. The computer device includes a processor, a memory, an input/output (I/O) interface, and a communication interface. The processor, the memory, and the input/output interface are connected through a system bus. The communication interface is connected to the system bus through the input/output interface. The processor of the computer device is configured to provide calculation and control capabilities. The memory of the computer device includes a non-volatile storage medium and an internal memory. The non-volatile storage medium has an operating system, a computer program, and a database stored therein. The internal memory provides a running environment for the operating system and the computer program in the non-volatile storage medium. The database of the computer device is configured to store data related to an environmental category and data related to an identity recognition algorithm. The input/output interface of the computer device is configured to exchange information between the processor and an external device. The communication interface of the computer device is configured to be connected to an external terminal for communication by using a network. The computer program, when executed by the processor, causes an identity recognition method to be implemented.

A person skilled in the art may understand that the structure shown in FIG. 14 is merely a block diagram of a partial structure related to the solutions of the present disclosure, and does not constitute a limitation on the computer device to which the solutions of the present disclosure are applied. Specifically, the computer device may include more or fewer components than those shown in the figure, have some components combined, or have a different component arrangement.

In an embodiments, a computer device is provided, including a memory and a processor. The memory has a computer program stored therein. The processor, when executing the computer program, implements the operations in each of the foregoing method embodiments.

In an embodiment, a computer-readable storage medium is provided, having a computer program stored herein. The computer program, when executed by a processor, causes the operations in each of the foregoing method embodiments to be implemented.

In an embodiment, a computer program product is provided, including a computer program. The computer program, when executed by a processor, causes the operations in each of the foregoing method embodiments to be implemented.

Information (including, but not limited to, user equipment information, user personal information, and the like) and data (including, but not limited to, data for analysis, stored data, displayed data, and the like) involved in the present disclosure are all information and data authorized by users or fully authorized by all parties, and collection, use, and processing of relevant data need to comply with relevant laws, regulations, and standards of relevant countries and regions.

A person of ordinary skill in the art may understand that all or a part of procedures of the method in the foregoing embodiments may be implemented by a computer program instructing relevant hardware. The computer program may be stored in a non-volatile computer-readable storage medium. When the computer program is executed, the procedures of the foregoing method embodiments may be performed. References to the memory, the database, or another medium used in the embodiments provided in the present disclosure may all include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache, or the like. For the purpose of illustration rather than limitation, the RAM may be in various forms, for example, a static random access memory (SRAM) or a dynamic random access memory (DRAM). The database involved in the embodiments provided in the present disclosure may include at least one of a relational database and a non-relational database. The non-relational database may include but is not limited to a blockchain-based distributed database and the like. The processor involved in the embodiments provided by the present disclosure may be but is not limited to a general-purpose processor, a central processing unit, a graphics processing unit, a digital signal processor, a programmable logic device, a quantum computing-based data processing logic device, and the like.

The technical features in the foregoing embodiments may be combined in any manner. To make the description brief, not all possible combinations of the technical features in the foregoing embodiments are described. However, provided that the combinations of the technical features do not conflict with each other, the combinations shall be considered as falling within the scope recorded in this specification.

The foregoing embodiments merely illustrates several implementations of the present disclosure, and the descriptions thereof are relatively specific and detailed, but are not to be construed as a limitation on the patent scope of the present disclosure. For a person of ordinary skill in the art, several transformations and improvements can be made without departing from the idea of the present disclosure. These transformations and improvements shall fall within the protection scope of the present disclosure. Therefore, the patent protection scope of the present disclosure shall be subject to the appended claims.

What is claimed is:

1. An identity recognition method, performed by a computer device, the method comprising:
obtaining a target image, the target image comprising an image formed from at least a part of a target object;
extracting a color feature of the target image;
recognizing, based on the color feature of the target image, a target environmental category corresponding to the target image, different environmental categories being configured for characterizing different ambient light scenarios; and
obtaining, based on the target environmental category, a target identity recognition algorithm matching the target image, and performing identity recognition on the target image based on the target identity recognition algorithm, to obtain an identity recognition result of the target object, different environmental categories corresponding to different identity recognition algorithms.

2. The method according to claim 1, wherein the color feature of the target image is at least configured for characterizing ambient chromaticity information, and recognizing, based on the color feature of the target image, the target environmental category corresponding to the target image comprises:
inputting the color feature of the target image to a pre-obtained image classification model to obtain the target environmental category that is outputted by the image classification model and that corresponds to the target image, the image classification model being obtained through training based on a color feature and an environmental category label of a sample image, different environmental category labels being configured for characterizing different ambient light scenarios, and the color feature of the sample image being at least configured for characterizing ambient chromaticity information of an ambient light scenario corresponding to the sample image.

3. The method according to claim 1, wherein extracting the color feature of the target image comprises:
obtaining a red-green-blue (RGB) value of a pixel of the target image;
determining hue information of the target image based on an RGB value distribution of the pixel of the target image;
converting the RGB value of the pixel of the target image into a lightness value of the target image; and
constructing a color feature vector of the target image based on the lightness value of the target image and the hue information of the target image, to obtain the color feature of the target image.

4. The method according to claim 3, wherein determining the hue information of the target image based on the RGB value distribution of the pixel of the target image comprises:
mapping the RGB value of the pixel of the target image to an RGB coordinate system;
determining, based on a color space of a preset hue and the RGB value of the pixel of the target image, a target color space having a maximum quantity of pixels in the RGB coordinate system; and
determining a hue corresponding to the target color space as the hue information of the target image.

5. The method according to claim 3, wherein the color feature of the target image comprises the lightness value of the target image and the hue information of the target image; and recognizing, based on the color feature of the target image, the target environmental category corresponding to the target image comprises:
determining that the target environmental category corresponding to the target image is a dim light category in response to the lightness value of the target image being less than a preset first threshold and the hue information of the target image matching a preset first hue, the first hue being configured for characterizing hue information corresponding to an image of the dim light category.

6. The method according to claim 3, wherein the color feature of the target image comprises the lightness value of the target image and the hue information of the target image; and recognizing, based on the color feature of the target image, the target environmental category corresponding to the target image comprises:
determining that the target environmental category corresponding to the target image is a white light category in response to the lightness value of the target image being greater than a preset second threshold and the hue information of the target image matching a preset second hue, the second threshold being greater than or equal to the first threshold, and the second hue being configured for characterizing hue information corresponding to an image of the white light category.

7. The method according to claim 3, wherein the color feature of the target image comprises the lightness value of the target image and the hue information of the target image; and recognizing, based on the color feature of the target image, the target environmental category corresponding to the target image comprises:
determining that the target environmental category corresponding to the target image is a stray light category in response to that the hue information of the target image does not match the preset first hue and does not match the preset second hue.

8. The method according to claim 7, wherein further comprising:
determining, based on the hue information of the target image, a color category matching the hue information; and
determining the color category as a subcategory under the target environmental category corresponding to the target image.

9. The method according to claim 2, wherein the target image carries a device identifier of a target image acquisition device, and the target image is acquired by the target image acquisition device; and recognizing the target environmental category corresponding to the target image comprises:
determining, based on a pre-established matching relationship between a device identifier of an image acquisition device and an environmental category, the environmental category matching the device identifier of the target image acquisition device, and determining the environmental category matching the device identifier of the target image acquisition device as the target environmental category corresponding to the target image, the matching relationship between the device identifier of the image acquisition device and the environmental category being a matching relationship established between the device identifier and an environmental category determined based on a color feature of an ambient light scenario of an environment in which the image acquisition device is located.

10. The method according to claim 9, further comprising:
obtaining an environmental image acquired by an image acquisition device, the image acquisition device having a corresponding device identifier;
extracting a color feature of the environmental image;
inputting the color feature of the environmental image to the pre-obtained image classification model to obtain an environmental category that is outputted by the image classification model and that corresponds to the environmental image; and
establishing a matching relationship between the environmental category corresponding to the environmental image and the device identifier of the image acquisition device.

11. The method according to claim 10, further comprising:
determining, based on the color feature of the environmental image, whether there is ambient light interference in the environmental image, the environmental image being acquired by the corresponding image acquisition device;
returning, when it is determined that there is the ambient light interference in the environmental image, an application adjustment parameter for the ambient light interference to the image acquisition device corresponding to the environmental image, to indicate the image acquisition device to perform parameter adjustment based on the application adjustment parameter; and
obtaining an environmental image re-acquired by the image acquisition device adjusted based on the application adjustment parameter, and extracting a color feature of the re-acquired environmental image.

12. The method according to claim 11, wherein determining, based on the color feature of the environmental image, whether there is ambient light interference in the environmental image comprises:
obtaining brightness information and color noise of the environmental image based on the color feature of the environmental image, the brightness information comprising an overall brightness parameter of the environmental image or a brightness distribution of a pixel of the environmental image; and
determining that there is the ambient light interference in the environmental image when the overall brightness parameter of the environmental image is less than a preset brightness threshold, the brightness distribution of the pixel of the environmental image is not target distribution, or the color noise of the environmental image is greater than or equal to a preset color noise threshold.

13. The method according to claim 1, further comprising:
determining, based on the color feature of the target image, whether there is ambient light interference in the target image, the target image being acquired by a corresponding image acquisition device;
returning, when it is determined that there is the ambient light interference in the target image, an application adjustment parameter for the ambient light interference to the image acquisition device corresponding to the target image, to indicate the image acquisition device to perform parameter adjustment based on the application adjustment parameter; and
obtaining a target image re-acquired by the image acquisition device adjusted based on the application adjustment parameter, and extracting a color feature of the re-acquired target image.

14. The method according to claim 13, wherein determining, based on the color feature of the target image, whether there is the ambient light interference in the target image comprises:
obtaining brightness information and color noise of the target image based on the color feature of the target image, the brightness information of the target image comprising an overall brightness parameter of the target image or a brightness distribution of the pixel of the target image; and
determining that there is the ambient light interference in the target image when the overall brightness parameter of the target image is less than the preset brightness threshold, the brightness distribution of the pixel of the target image is not the target distribution, or the color noise of the target image is greater than or equal to the preset color noise threshold.

15. The method according to claim 1, further comprising:
obtaining a sample image set, the sample image set comprising a plurality of sample images and environmental category labels of the sample images, the environmental category labels being determined based on ambient light scenarios in which acquisition devices of the sample images are located, and the environmental category label comprising a white light category label, a dim light category label, and a stray light category label;
extracting color features of the sample images;
invoking, based on the color feature of each sample image, an initial classification model to classify each sample image, to obtain a predicted environmental category of each sample image; and
training the initial classification model based on the environmental category label and the predicted environmental category of each sample image, to obtain the image classification model.

16. The method according to claim 15, wherein the target image comprises an infrared image and a color image; and obtaining, based on the target environmental category, the target identity recognition algorithm matching the target image, and performing the identity recognition on the target image based on the target identity recognition algorithm, to obtain the identity recognition result of the target object comprises:
performing, in response to that the target environmental category is the white light category, first recognition on the color image to obtain a first recognition result, and performing second recognition on the infrared image to obtain a second recognition result; and
performing equal-weight weighted processing on the first recognition result and the second recognition result to obtain the identity recognition result of the target object.

17. The method according to claim 16, wherein the target image comprises the infrared image and the color image; and obtaining, based on the target environmental category, the target identity recognition algorithm matching the target image, and performing the identity recognition on the target image based on the target identity recognition algorithm, to obtain the identity recognition result of the target object comprises:
obtaining brightness of the color image in response to the target environmental category being the stray light category; determining a first recognition weight of the color image and a second recognition weight of the infrared image based on the brightness of the color image; performing first recognition based on the color image, to obtain the first recognition result, and performing second recognition based on the infrared image, to obtain the second recognition result; and obtaining the identity recognition result of the target object based on the first recognition result and the first recognition weight of the color image and the second recognition result and the second recognition weight of the infrared image, or
in response to the target environmental category being the dim light category, performing identity recognition on the infrared image to obtain the identity recognition result of the target object.

18. The method according to claim 1, wherein the identity recognition method is applied to a resource transfer scenario, and obtaining the target image comprises:
obtaining a resource transfer request, and invoking an image acquisition device to acquire a target image of an object intended to perform resource transfer, the target image comprising a palm image of the object intended to perform resource transfer; and
the method further comprises:
performing a resource transfer operation based on the resource transfer request when the identity recognition result indicates that identity recognition of the object intended to perform resource transfer succeeds.

19. A computer device, comprising one or more processors and a memory containing a computer program that, when being executed, causes the one or more processors to perform:
obtaining a target image, the target image comprising an image formed from at least a part of a target object;
extracting a color feature of the target image;
recognizing, based on the color feature of the target image, a target environmental category corresponding to the target image, different environmental categories being configured for characterizing different ambient light scenarios; and
obtaining, based on the target environmental category, a target identity recognition algorithm matching the target image, and performing identity recognition on the target image based on the target identity recognition algorithm, to obtain an identity recognition result of the target object, different environmental categories corresponding to different identity recognition algorithms.

20. A non-transitory computer-readable storage medium containing a computer program that, when being executed, causes at least one processor to perform:
obtaining a target image, the target image comprising an image formed from at least a part of a target object;
extracting a color feature of the target image;
recognizing, based on the color feature of the target image, a target environmental category corresponding to the target image, different environmental categories being configured for characterizing different ambient light scenarios; and
obtaining, based on the target environmental category, a target identity recognition algorithm matching the target image, and performing identity recognition on the target image based on the target identity recognition algorithm, to obtain an identity recognition result of the target object, different environmental categories corresponding to different identity recognition algorithms.
